(19) United States
(12) Patent Application Publication
(10) Pub. No.: US 2019/0196178 A1
(43) Pub. Date: Jun. 27, 2019

(54) ACTUATOR AND LIGHT SCANNING DEVICE

(71) Applicant: Kensuke YAMADA, Tokyo (JP)

(72) Inventor: Kensuke YAMADA, Tokyo (JP)

(73) Assignee: MITSUMI ELECTRIC CO., LTD., Tokyo (JP)

(21) Appl. No.: 16/223,690

(22) Filed: Dec. 18, 2018

(30) Foreign Application Priority Data
Dec. 27, 2017 (JP) 2017-251834

(51) Int. Cl. G02B 26/08; G02B 26/10

(52) U.S. Cl. CPC G02B 26/0858; G02B 26/10

(57) ABSTRACT

An actuator according to an aspect of the present invention includes an actuation object, a first actuating beam supporting the actuation object, a fixing frame supporting the first actuating beam, a first actuation source configured to cause the actuation object to oscillate around a first axis, by actuating the first actuating beam, a first wiring pattern for failure detection drawn on the first actuating beam, and a terminal of the first wiring pattern for failure detection disposed on the fixing frame.

### CROSS-REFERENCE TO RELATED APPLICATION

This patent application is based on and claims priority to Japanese Patent Applications No. 2017-251834 filed on Dec. 27, 2017, the entire contents of which are hereby incorporated by reference.

### BACKGROUND OF THE INVENTION

### 1. Field of the Invention

The present invention relates to an actuator and a light scanning device.

### 2. Description of the Related Art

Conventionally, there is known a light scanning device that scans light by causing a mirror to oscillate around a rotating axis, using an actuator having a piezoelectric element, an upper electrode formed on the piezoelectric element, and a lower electrode formed under the piezoelectric element. In the light scanning device, an upper wire connecting to the upper electrode and a lower wire connecting to the lower electrode are formed, in order to apply voltage to the piezoelectric element (see Patent Document 1, for example).

An actuator for a light scanning device disclosed in Patent Document 2 includes multiple beams forming a meander shape. Because a sensor for detecting displacement is provided on one of the beams located at an outermost position (hereinafter, this beam is referred to as an “outermost beam”), a displacement of the outermost beam can be detected by the sensor, and whether or not the actuator is generating a desired vibration can be detected.

In the actuator disclosed in Patent Document 2, when a malfunction occurs in the outermost beam, the malfunctions can be detected by the sensor. However, in a case in which breakage occurs in a beam located inwards from the outermost beam and in which the outermost beam is operating normally, the malfunction cannot be detected by the sensor. If a sensor is provided on each of the beams located inwards from the outermost beam, malfunction may be detected. However, in this case, as the same number of wires as the number of the sensors is required, the beams need to be thicker for placing the wires.

### CITATION LIST

### Patent Document

### [Patent Document 1] Japanese Laid-open Patent Application Publication No. 2016-001325

### [Patent Document 2] Japanese Laid-open Patent Application Publication No. 2017-068205

### SUMMARY OF THE INVENTION

An actuator according to an aspect of the present invention includes an actuation object, a first actuating beam supporting the actuation object, a fixing frame supporting the first actuating beam, a first actuation source configured to cause the actuation object to oscillate around a first axis, by actuating the first actuating beam, a first wiring pattern for failure detection drawn on the first actuating beam, and a terminal of the first wiring pattern for failure detection disposed on the fixing frame.

### BRIEF DESCRIPTION OF THE DRAWINGS

FIG. 1 a plan view illustrating an example of an upper surface of a light scanning unit in a light scanning device according to a first embodiment;

FIG. 2 is a schematic diagram of a failure detecting circuit for the light scanning unit according to the first embodiment;

FIG. 3 is a plan view illustrating an example of an upper surface of a light scanning unit in a light scanning device according to a second embodiment;

FIG. 4 is a plan view illustrating another example of a light scanning unit in a light scanning device according to the second embodiment;

FIG. 5 is a plan view illustrating yet another example of a light scanning unit in a light scanning device according to the second embodiment;

FIG. 6 is a schematic diagram of a failure detecting circuit for the light scanning unit according to the second embodiment;

FIG. 7 is a plan view illustrating an example of an upper surface of a light scanning unit in a light scanning device according to a third embodiment;

FIG. 8 is a plan view illustrating an example of an upper surface of a light scanning unit in a light scanning device according to a fourth embodiment;

FIG. 9 is a plan view illustrating an example of an upper surface of a light scanning unit in a light scanning device according to a fifth embodiment;

FIG. 10 is a plan view illustrating an example of an upper surface of a light scanning unit in a light scanning device according to a sixth embodiment; and

FIG. 11 is a plan view illustrating another example of an upper surface of a light scanning unit in a light scanning device according to the sixth embodiment.

### DETAILED DESCRIPTION OF THE PREFERRED EMBODIMENTS

In the following, embodiments of the present disclosure will be described with reference to the drawings. Note that, in the drawings, elements having substantially identical features are given the same reference symbols and overlapping descriptions may be omitted.

### First Embodiment

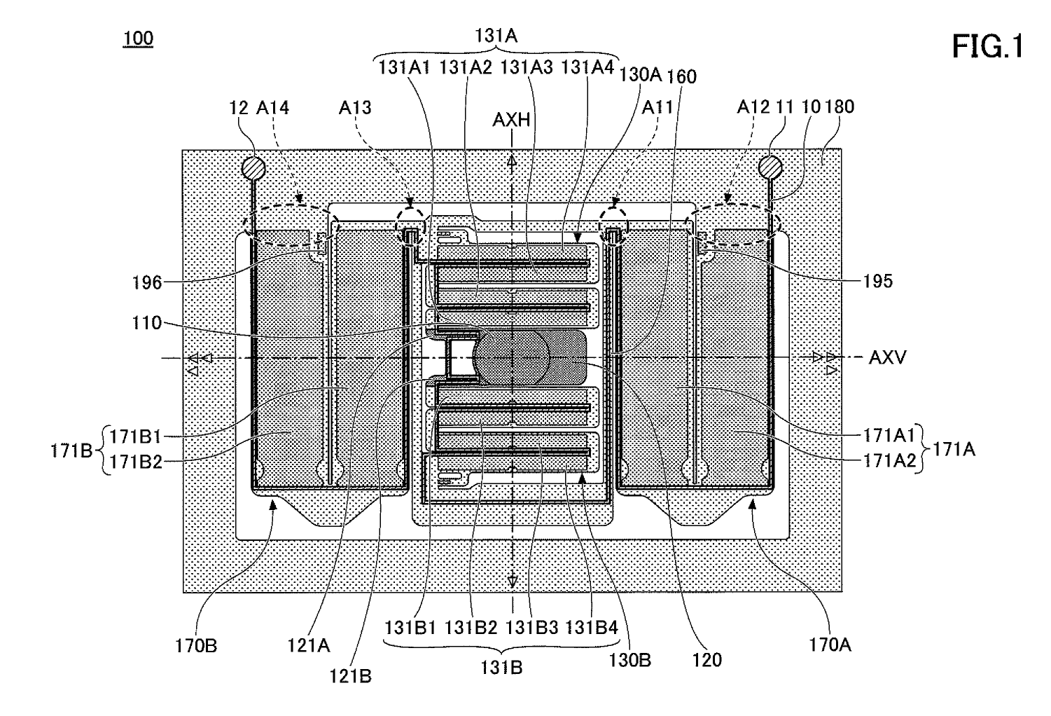

FIG. 1 is a plan view illustrating an example of an upper surface of a light scanning unit in a light scanning device according to a first embodiment. The light scanning unit 100 according to the present embodiment can be operated in a state in which the light scanning unit 100 is housed in a package member such as a ceramic package.

The light scanning unit 100 scans laser light emitted from a light source, by oscillating a mirror 110. The light scanning unit 100 is, for example, a MEMS (Micro Electro Mechanical Systems) mirror that drives a mirror 110 by a piezoelectric element. By reflecting incident light (laser light) using the mirror 110, the light scanning unit 100 performs two-dimensional scanning of light.

As illustrated in FIG. 1, the light scanning unit 100 includes the mirror 110, a mirror support (may also be referred to as a “mirror supporting member”) 120, connecting beams 121A and 121B, horizontal actuating beams 130A and 130B, a movable frame 160, vertical actuating beams 170A and 170B, and a fixing frame 180. The mirror 110 is supported on the mirror support 120.

At both sides of the mirror support 120 supporting the mirror 110, the horizontal actuating beams 130A and 130B are provided respectively. The horizontal actuating beams 130A and 130B are connected to the mirror support 120 via the connecting beams 121A and 121B, respectively. The horizontal actuating beams 130A and 130B, the connecting beams 121A and 121B, the mirror support 120, and the mirror 110 are supported by the movable frame 160 from outside. The horizontal actuating beam 130A includes multiple horizontal beams of rectangular shape arranged side by side, each of which extends in a direction of a vertical oscillating axis AXV orthogonal to a horizontal oscillating axis AXH. Further, since one end of each horizontal beam is connected (linked) to an end of one of two adjacent horizontal beams, with the other end of the horizontal beam being connected (linked) to an end of the other of the two adjacent horizontal beams, the horizontal actuating beam 130A has a meander shape as a whole. One end of the horizontal actuating beam 130A is connected to an inner edge of the movable frame 160, and the other end of the horizontal actuating beam 130A is connected to the mirror support 120. The horizontal actuating beam 130B also includes multiple horizontal beams of rectangular shape arranged side by side, each of which extends in the direction of the vertical oscillating axis AXV. Further, since one end of each horizontal beam is connected (linked) to an end of one of two adjacent horizontal beams, with the other end of the horizontal beam being connected (linked) to an end of the other of the two adjacent horizontal beams, the horizontal actuating beam 130B has a meander shape as a whole. One end of the horizontal actuating beam 130B is connected to an inner edge of the movable frame 160, and the other end of the horizontal actuating beam 130B is connected to the mirror support 120.

In addition, at both sides of the movable frame 160, the vertical actuating beams 170A and 170B are provided respectively. The vertical actuating beam 170A includes multiple vertical beams of rectangular shape arranged side by side, each of which extends in a direction of the horizontal oscillating axis AXH. Since one end of each vertical beam is connected (linked) to an end an adjacent vertical beam, the vertical actuating beam 170A has a meander shape as a whole. One end of the vertical actuating beam 170A is connected to an inner edge of the fixing frame 180, and the other end of the vertical actuating beam 170A is connected to an outer edge of the movable frame 160. The vertical actuating beam 170B also includes multiple vertical beams of rectangular shape arranged side by side, each of which extends in a direction of the horizontal oscillating axis AXH. Since one end of each vertical beam is connected (linked) to an end of an adjacent vertical beam, the vertical actuating beam 170B has a meander shape as a whole. One end of the vertical actuating beam 170B is connected to an inner edge of the fixing frame 180, and the other end of the vertical actuating beam 170B is connected to an outer edge of the movable frame 160.

The horizontal actuating beams 130A and 130B include horizontal actuation sources 131A and 131B respectively. Also, the vertical actuating beams 170A and 170B include vertical actuation sources 171A and 171B respectively. The horizontal actuation beams 130A and 130B and the vertical actuation beams 170A and 170B serve as actuators for scanning laser light by causing the mirror 110 to oscillate horizontally and vertically.

On each of the horizontal beams (not including curved portions) on an upper surface of the horizontal actuating beam 130A, the horizontal actuation source 131A is formed. Similarly, on each of the horizontal beams (not including curved portions) on an upper surface of the horizontal actuating beam 130B, the horizontal actuation source 131B is formed. The horizontal actuation source 131A includes a piezoelectric thin film formed on the upper surface of the horizontal actuating beam 130A, an upper electrode formed on the piezoelectric thin film, and a lower electrode formed under the piezoelectric thin film. The horizontal actuation source 131B includes a piezoelectric thin film formed on the upper surface of the horizontal actuating beam 130B, an upper electrode formed on the piezoelectric thin film, and a lower electrode formed under the piezoelectric thin film.

To each of the horizontal beams in the horizontal actuating beams 130A and 130B, drive voltage having different polarity from that applied to an adjacent horizontal beam is applied. As a result, each of the horizontal beams in the horizontal actuating beams 130A and 130B bends in a different direction from the adjacent horizontal beam, and accumulated displacement from each of the horizontal beams is propagated to the mirror support 120. By the above mentioned operation of the horizontal actuating beams 130A and 130B, the mirror 110 and the mirror support 120 oscillate in a manner in which the mirror 110 and the mirror support 120 rotate around the horizontal oscillating axis AXH (which passes through a center of a reflecting surface of the mirror 110). In the present embodiment, this direction of the rotation (oscillation) of the mirror 110 (and the mirror support 120) is referred to as a “horizontal direction”. For example, a non-resonant vibration mode may be used for the horizontal actuation of the horizontal actuating beams 130A and 130B.

For example, the horizontal actuation source 131A includes four horizontal actuation sources 131A1, 131A2, 131A3, and 131A4, which are respectively formed on first, second, third, and fourth horizontal beams constituting the horizontal actuating beam 130A. The horizontal actuation source 131B also includes four horizontal actuation sources 131B1, 131B2, 131B3, and 131B4, which are respectively formed on first, second, third, and fourth horizontal beams constituting the horizontal actuating beam 130B. In this case, if the actuation sources 131A1, 131B1, 131A3, and 131B3 are actuated by voltage having the same waveform being applied, and if the actuation sources 131A2, 131E32, 131A4, and 131B4 are actuated by voltage having opposite polarity from that applied to the actuation sources 131A1 and the like, the mirror 110 and the mirror support 120 are caused to oscillate in a horizontal direction.

On each of the vertical beams (not including curved portions) on an upper surface of the vertical actuating beam 170A, the vertical actuation source 171A is formed. Similarly, on each of the vertical beams (not including curved portions) on an upper surface of the vertical actuating beam 170B, the vertical actuation source 171B is formed. The vertical actuation source 171A includes a piezoelectric thin film formed on the upper surface of the vertical actuating beam 170A, an upper electrode formed on the piezoelectric thin film, and a lower electrode formed under the piezoelectric thin film. The vertical actuation source 171B includes a piezoelectric thin film formed on the upper surface of the vertical actuating beam 170B, an upper electrode formed on the piezoelectric thin film, and a lower electrode formed under the piezoelectric thin film.

To each of the vertical beams in the vertical actuating beams 170A and 170B, drive voltage having different polarity from that applied to an adjacent vertical beam is applied. As a result, each of the vertical beams in the vertical actuating beams 170A and 170B bends in a different direction from the adjacent vertical beam, and accumulated displacement from each of the vertical beams is propagated to the movable frame 160. By the above mentioned operation of the vertical actuating beams 170A and 170B, the mirror 110 and the mirror support 120 oscillate in a manner in which the mirror 110 and the mirror support 120 rotate around an axis which is orthogonal to the horizontal oscillating axis AXH and which passes through a center of a reflecting surface of the mirror 110. In the present embodiment, this direction of the rotation (oscillation) of the mirror 110 is referred to as a “vertical direction”, and the axis which is orthogonal to the horizontal oscillating axis AXH and which passes through the center of the reflecting surface of the mirror 110 is referred to as the vertical oscillating axis AXV. For example, a non-resonant vibration mode may be used for the vertical actuation of the vertical actuating beams 170A and 170B.

For example, the vertical actuation source 171A includes two vertical actuation sources 171A1 and 171A2, which are respectively formed on first and second vertical beams constituting the vertical actuating beam 170A. The vertical actuation source 171B also includes two vertical actuation sources 17181 and 171B2, which are respectively formed on first and second vertical beams constituting the vertical actuating beam 170B. In this case, if the actuation sources 171A1 and 171B1 are actuated by voltage having the same waveform, and if the actuation sources 171A2 and 171B2 are actuated by voltage having opposite polarity from that applied to the actuation sources 171A1 and 171B1, the movable frame 160 connected to the mirror 110 is caused to oscillate in a vertical direction.

In the light scanning device according to the present embodiment, a MEMS structure functioning as an actuator is formed of an SOI substrate including a support layer, a buried oxide (BOX) layer, and an active layer, for example. The fixing frame 180 and the movable frame 160 described above are formed of a support layer, a BOX layer, and an active layer. On the other hand, parts of the light scanning device other than the fixing frame 180 and the movable frame 160, such as the horizontal actuating beams 130A and 130B and the vertical actuating beams 170A and 170B, are formed of a single layer of an active layer, or may be formed of a BOX layer and an active layer.

On the outermost vertical beam of the vertical actuating beam 170A, a displacement sensor 195 for acquiring displacement is formed. On the outermost vertical beam of the vertical actuating beam 170B, a displacement sensor 196 for acquiring displacement is formed. Based on signals acquired from the displacement sensors 195 and 196, displacement of the outermost vertical beam of the vertical actuating beam 170A and the outermost vertical beam of the vertical actuating beam 170B can be detected, and whether or not a desired vibration is generated by the vertical actuating beams 170A and 170B can be detected.

In the light scanning device according to the present embodiment, a wiring pattern for failure detection 10 is formed on the vertical actuating beams 170A and 170B and the horizontal actuating beams 130A and 130B. Terminals 11 and 12 are formed at one end of the wiring pattern for failure detection 10 and the other end of the wiring pattern for failure detection 10 respectively. Each of the terminals 11 and 12 is formed on the fixing frame 180. From the terminal 11 on the fixing frame 180, the wiring pattern for failure detection 10 is drawn on the vertical actuating beam 170A via a connecting member A12, drawn on the movable frame 160 via a connecting member A11, and further drawn on the horizontal actuating beam 130B and the connecting beams 121B and 121A. The wiring pattern for failure detection 10 is further drawn, from the connecting beams 121B and 121A, on the horizontal actuating beam 130A, drawn on the vertical actuating beam 170B via a connecting member A13, and drawn to the terminal 12 on the fixing frame 180 via a connecting member.

The light scanning device according to the present embodiment is configured to be capable of detecting whether an actuating beam on which a wiring pattern for failure detection is drawn has breakage or not, by checking a conduction state between the terminals 11 and 12. That is, in a case in which a path between the terminals 11 and 12 is in a conductive state, it is determined that no breakage occurs in actuating beams on which a wiring pattern for failure detection is drawn. Conversely, in a case in which a path between the terminals 11 and 12 is not in a conductive state, it is determined that breakage occurs at a certain point in actuating beams on which a wiring pattern for failure detection is drawn. As described above, in a MEMS structure functioning as an actuator, in a case in which breakage occurs in a beam located inwards from an outermost beam, the breakage can be detected regardless of whether a displacement sensor is present or not.

The wiring pattern for failure detection in the light scanning device according to the present embodiment does not detect a variation of an amount of vibration of an actuating beam, but can be used for determination as to whether or not breakage occurs in an actuating beam. By providing the wiring pattern for failure detection, detection of breakage in an actuating beam can be realized. Also, as voltage applied to the wiring pattern for failure detection may be low, a thin wiring pattern can be used as the wiring pattern for failure detection. As the required number of the wiring patterns is one, at minimum, providing the wiring pattern for failure detection on a beam (such as the horizontal actuating beam and the vertical actuating beam) has little effect on beam width as compared to a case in which additional displacement sensors are provided.

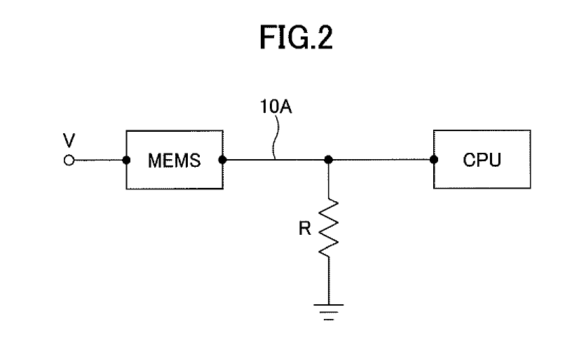

FIG. 2 is a schematic diagram of a failure detecting circuit for the light scanning unit 100 according to the present embodiment. A wiring pattern for failure detection 10A is drawn on a MEMS structure such as the vertical actuating beams 170A and 170B and the horizontal actuating beams 130A and 130B. Voltage V such as power supply voltage is applied to one of terminals of the wiring pattern for failure detection 10A. The other terminal of the wiring pattern for failure detection 10A is connected to an input terminal of a signal processing unit such as a CPU (Central Processing Unit), and the CPU can observe an output of the other terminal in real time. An intermediate section of the wiring pattern for failure detection 10A is grounded via a resistance element R. In a case in which the failure detecting circuit is configured as illustrated in FIG. 2, if the MEMS structure such as the vertical actuating beams 170A and 170B and the horizontal actuating beams 130A and 130B is not in failure, the voltage V is input to the input terminal of the CPU. Conversely, if disconnection occurs at any point of the MEMS structure such as the vertical actuating beams 170A and 170B and the horizontal actuating beams 130A and 130B, the input terminal of the CPU is grounded. In a case in which a value between the ground voltage and the voltage V is defined as a threshold, when voltage below the threshold is input to the CPU, it is determined that disconnection occurs at any point within the MEMS structure. Note that a circuit used for checking a conduction state of a wiring pattern for failure detection is not limited to the circuit illustrated in FIG. 2. Other circuits may be used for checking a conduction state.

### Second Embodiment

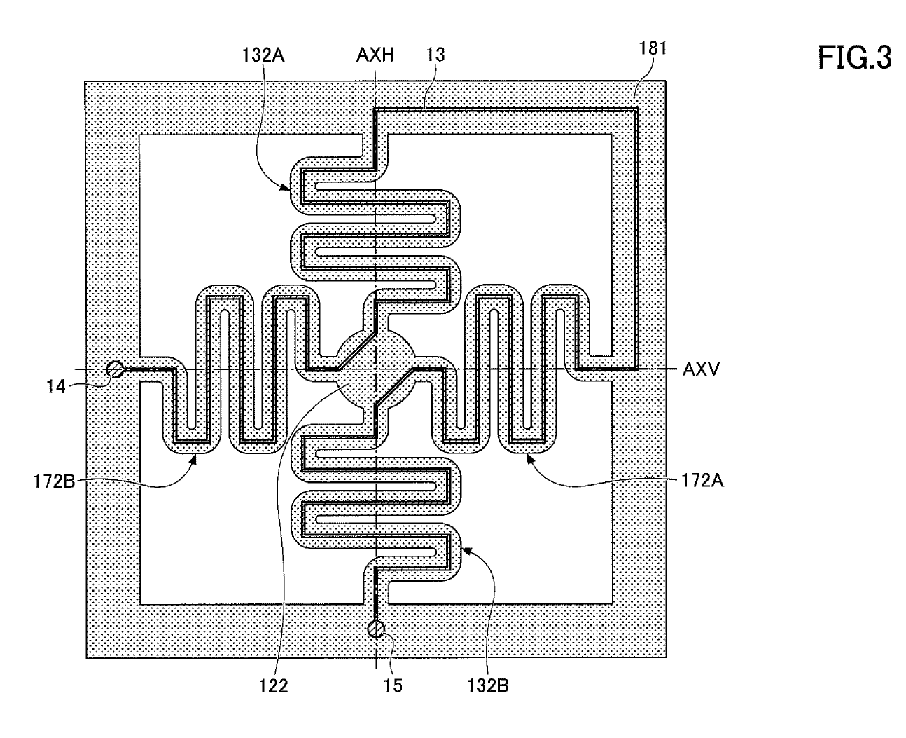

FIG. 3 is a plan view illustrating an example of an upper surface of a light scanning unit in a light scanning device according to a second embodiment. The light scanning unit includes a mirror, a mirror support 122, horizontal actuating beams 132A and 132B, vertical actuating beams 172A and 172B, and a fixing frame 181. The mirror is supported on the mirror support 122. At both sides of the mirror support 122 supporting the mirror, in a direction of a horizontal oscillating axis AXH, the horizontal actuating beams 132A and 132B are provided respectively. Each of the horizontal actuating beams 132A and 132B is connected to the mirror support 122 at one end, and is connected to the fixing frame 181 at the other end. Each of the horizontal actuating beams 132A and 132B includes multiple horizontal beams of rectangular shape arranged side by side, each of which extends in a direction of a vertical oscillating axis AXV orthogonal to the horizontal oscillating axis AXH. Since one end of each horizontal beam is connected (linked) to an end of one of two adjacent horizontal beams, with the other end of the horizontal beam being connected (linked) to an end of the other of the two adjacent horizontal beams, the horizontal actuating beams 132A and 132B have a meander shape as a whole.

At both sides of the mirror support 122 supporting the mirror, in a direction of the vertical oscillating axis AXV, the vertical actuating beams 172A and 172B are provided respectively. Each of the vertical actuating beams 172A and 172B is connected to the mirror support 122 at one end, and is connected to the fixing frame 181 at the other end. Each of the vertical actuating beams 172A and 172B includes multiple vertical beams of rectangular shape arranged side by side, each of which extends in a direction of the horizontal oscillating axis AXH orthogonal to the vertical oscillating axis AXV. Since one end of each vertical beam is connected (linked) to an end of one of two adjacent vertical beams, with the other end of the vertical beam being connected (linked) to an end of the other of the two adjacent vertical beams, the vertical actuating beams 172A and 172B have a meander shape as a whole.

On each of the horizontal actuating beams 132A and 132B, a horizontal actuation source is formed. Also, on each of the vertical actuating beams 172A and 172B, a vertical actuation source is formed. The horizontal actuation beams 132A and 132B and the vertical actuation beams 172A and 172B serve as actuators for scanning laser light by causing the mirror support 122 to oscillate horizontally and vertically.

On upper surfaces of the horizontal actuating beams 132A and 132B, the horizontal actuation source is formed on each of the horizontal beams (not including curved portions). The horizontal actuation source includes a piezoelectric thin film, an upper electrode formed on the piezoelectric thin film, and a lower electrode formed under the piezoelectric thin film. To each of the horizontal beams in the horizontal actuating beams 132A and 132B, drive voltage having different polarity from that applied to an adjacent horizontal beam is applied. As a result, each of the horizontal beams in the horizontal actuating beams 132A and 132B bends in a different direction from the adjacent horizontal beam, and accumulated displacement from each of the horizontal beams is propagated to the mirror support 122. By the above mentioned operation of the horizontal actuating beams 132A and 132B, the mirror and the mirror support 122 oscillate in a manner in which the mirror and the mirror support 122 rotate around the horizontal oscillating axis AXH (which passes through a center of a reflecting surface of the mirror 110). In the present embodiment, this direction of the rotation (oscillation) of the mirror (and the mirror support 122) is referred to as a “horizontal direction”. For example, a non-resonant vibration mode may be used for the horizontal actuation of the horizontal actuating beams 132A and 132B.

On upper surfaces of the vertical actuating beams 172A and 172B, the vertical actuation source is formed on each of the vertical beams (not including curved portions). The vertical actuation source includes a piezoelectric thin film, an upper electrode formed on the piezoelectric thin film, and a lower electrode formed under the piezoelectric thin film. To each of the vertical beams in the vertical actuating beams 172A and 172B, drive voltage having different polarity from that applied to an adjacent vertical beam is applied. As a result, each of the vertical beams in the vertical actuating beams 172A and 172B bends in a different direction from the adjacent vertical beam, and accumulated displacement from each of the vertical beams is propagated to the movable frame 160. By the above mentioned operation of the vertical actuating beams 172A and 172B, the mirror and the mirror support 122 oscillate in a manner in which the mirror and the mirror support 122 rotate around the vertical oscillating axis AXV. In the present embodiment, this direction of the rotation (oscillation) of the mirror is referred to as a “vertical direction”, and the vertical oscillating axis AXV passes through the center of the reflecting surface of the mirror. For example, a non-resonant vibration mode may be used for the vertical actuation of the vertical actuating beams 172A and 172B.

In the light scanning device according to the present embodiment, a MEMS structure functioning as an actuator is formed of an SOI substrate including a support layer, a buried oxide (BOX) layer, and an active layer, for example. The above described fixing frame 180 and the like are formed of a support layer, a BOX layer, and an active layer. On the other hand, parts of the light scanning device such as the horizontal actuating beams 132A and 132B and the vertical actuating beams 172A and 172B, is formed of a single layer of an active layer, or may be formed of a BOX layer and an active layer.

In the light scanning device according to the present embodiment, a wiring pattern for failure detection 13 is formed on the vertical actuating beams 172A and 172B and the horizontal actuating beams 132A and 132B. Terminals 14 and 15 are formed at one end of the wiring pattern for failure detection 13 and the other end of the wiring pattern for failure detection 13 respectively. The terminals 14 and 15 are formed on the fixing frame 181. The wiring pattern for failure detection 13 is drawn from the terminal 14 (on the fixing frame 181) on the vertical actuating beam 172B, and drawn on the horizontal actuating beam 132A and the fixing frame 181 via the mirror support 122. From the fixing frame 181, the wiring pattern for failure detection 13 is further drawn on the vertical actuating beam 172A, and on the horizontal actuating beam 132B via the mirror support 122. Lastly, the wiring pattern for failure detection 13 is connected to the terminal 15 on the fixing frame 181.

The light scanning device according to the present embodiment illustrated in FIG. 3 is configured to be capable of detecting whether an actuating beam on which a wiring pattern for failure detection is drawn has breakage or not, by checking a conduction state between the terminals 14 and 15. That is, in a case in which a path between the terminals 14 and 15 is in a conductive state, it is determined that no breakage occurs in actuating beams on which a wiring pattern for, failure detection is drawn (the vertical actuating beams 172A and 172B and the horizontal actuating beams 132A and 132B). Conversely, in a case in which a path between the terminals 14 and 15 is not in a conductive state, it is determined that breakage occurs at a certain point in the actuating beams on which a wiring pattern for failure detection is drawn. By checking the conduction state between the terminals (14 and 15), presence or absence of breakage in an actuating beam can be determined. As described above, in a MEMS structure functioning as an actuator, in a case in which breakage occurs in a beam located inwards from an outermost beam, the breakage can be detected regardless of whether a displacement sensor is present or not.

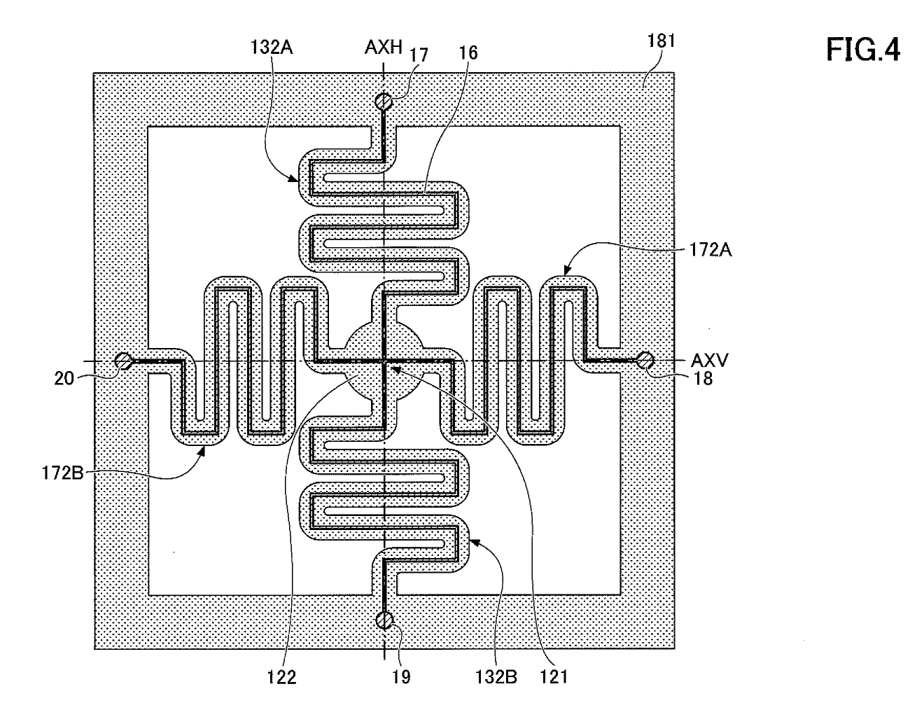

FIG. 4 is a plan view illustrating another example of a light scanning unit in a light scanning device according to the second embodiment. Except for a route of a wiring pattern for failure detection, a configuration of the light scanning unit in FIG. 4 is the same as that in FIG. 3. On a mirror support (actuation target), a set of wiring patterns for failure detection 16 in FIG. 4 has an intersection of wiring patterns drawn on vertical actuating beams and wiring patterns drawn on horizontal actuating beams. For example, a first one of the wiring patterns for failure detection 16 is drawn from a terminal 17 on a fixing frame 181 to a mirror support 122 via a horizontal actuating beam 132A. A second one of the wiring patterns for failure detection 16 is drawn from a terminal 18 on the fixing frame 181 to the mirror support 122 via a vertical actuating beam 172A. A third one of the wiring patterns for failure detection 16 is drawn from a terminal 19 on a fixing frame 181 to the mirror support 122 via a horizontal actuating beam 132B. A fourth one of the wiring patterns for failure detection 16 is drawn from a terminal 20 on the fixing frame 181 to the mirror support 122 via a vertical actuating beam 172B. An intersection of the above mentioned four wiring patterns for failure detection 16 is located at the center 121 of the mirror support 122.

The light scanning unit illustrated in FIG. 4 is configured to be capable of detecting whether an actuating beam on which a wiring pattern for failure detection is drawn has breakage or not, by checking a conduction state between any two terminals among the four terminals 17, 18, 19, and 20. That is, in a case in which a path between the terminals 17 and 18 is in a conductive state, it is determined that no breakage occurs in the horizontal actuating beam 132A and the vertical actuating beam 172A on which a wire for failure detection between the terminals 17 and 18 is drawn. Conversely, in a case in which the path between the terminals 17 and 18 is not in a conductive state, it is determined that breakage occurs at a certain point in the horizontal actuating beam 132A and the vertical actuating beam 172A on which the wire for failure detection between the terminals 17 and 18 is drawn. In a case in which a path between the terminals 17 and 19 is in a conductive state, it is determined that no breakage occurs in the horizontal actuating beams 132A and 132B on which a wire for failure detection between the terminals 17 and 19 is drawn. Conversely, in a case in which the path between the terminals 17 and 19 is not in a conductive state, it is determined that breakage occurs at a certain point in the horizontal actuating beams 132A and 132B on which the wire for failure detection between the terminals 17 and 19 is drawn. In a case in which a path between the terminals 17 and 20 is in a conductive state, it is determined that no breakage occurs in the horizontal actuating beam 132A and the vertical actuating beam 172B on which a wire for failure detection between the terminals 17 and 20 is drawn. Conversely, in a case in which the path between the terminals 17 and 20 is not in a conductive state, it is determined that breakage occurs at a certain point in the horizontal actuating beam 132A and the vertical actuating beam 172B on which the wire for failure detection between the terminals 17 and 20 is drawn. In a case in which a path between the terminals 18 and 19 is in a conductive state, it is determined that no breakage occurs in the vertical actuating beam 172A and the horizontal actuating beam 132B on which a wire for failure detection between the terminals 18 and 19 is drawn. Conversely, in a case in which the path between the terminals 18 and 19 is not in a conductive state, it is determined that breakage occurs at a certain point in the vertical actuating beam 172A and the horizontal actuating beam 132B on which the wire for failure detection between the terminals 18 and 19 is drawn. In a case in which a path between the terminals 18 and 20 is in a conductive state, it is determined that no breakage occurs in the vertical actuating beams 172A and 172B on which a wire for failure detection between the terminals 18 and 20 is drawn. Conversely, in a case in which the path between the terminals 18 and 20 is not in a conductive state, it is determined that breakage occurs at a certain point in the vertical actuating beams 172A and 172B on which the wire for failure detection between the terminals 18 and 20 is drawn. In a case in which a path between the terminals 19 and 20 is in a conductive state, it is determined that no breakage occurs in the horizontal actuating beam 132B and the vertical actuating beam 172B on which a wire for failure detection between the terminals 19 and 20 is drawn. Conversely, in a case in which the path between the terminals 19 and 20 is not in a conductive state, it is determined that breakage occurs at a certain point in the horizontal actuating beam 132B and the vertical actuating beam 172B on which the wire for failure detection between the terminals 19 and 20 is drawn.

In the light scanning unit illustrated in FIG. 4, for example, by checking conduction states of paths each connecting the terminal 17 with any one of the terminals 18, 19, and 20, it can be determined which of the actuating beams has breakage. For example, in a case in which electrical conduction cannot be detected from any of the paths each connecting the terminal 17 with one of the terminals 18, 19, and 20, it is determined that breakage occurs in the horizontal actuating beam 132A. Further, in a case in which electrical conduction cannot be detected from one of the above mentioned paths, it is determined that breakage occurs in an actuating beam corresponding to the path from which electrical conduction cannot be detected. That is, in such a case, if electrical conduction cannot be detected from a path between the terminal 17 and the terminal 18, it is determined that breakage occurs in the vertical actuating beam 172A. In such a case, if electrical conduction cannot be detected from a path between the terminal 17 and the terminal 19, it is determined that breakage occurs in the horizontal actuating beam 132B. In such a case, if electrical conduction cannot be detected from a path between the terminal 17 and the terminal 20, it is determined that breakage occurs in the vertical actuating beam 172B. As described above, in a MEMS structure functioning as an actuator, in a case in which breakage occurs in a beam located inwards from an outermost beam, the breakage can be detected regardless of whether a displacement sensor is present or not.

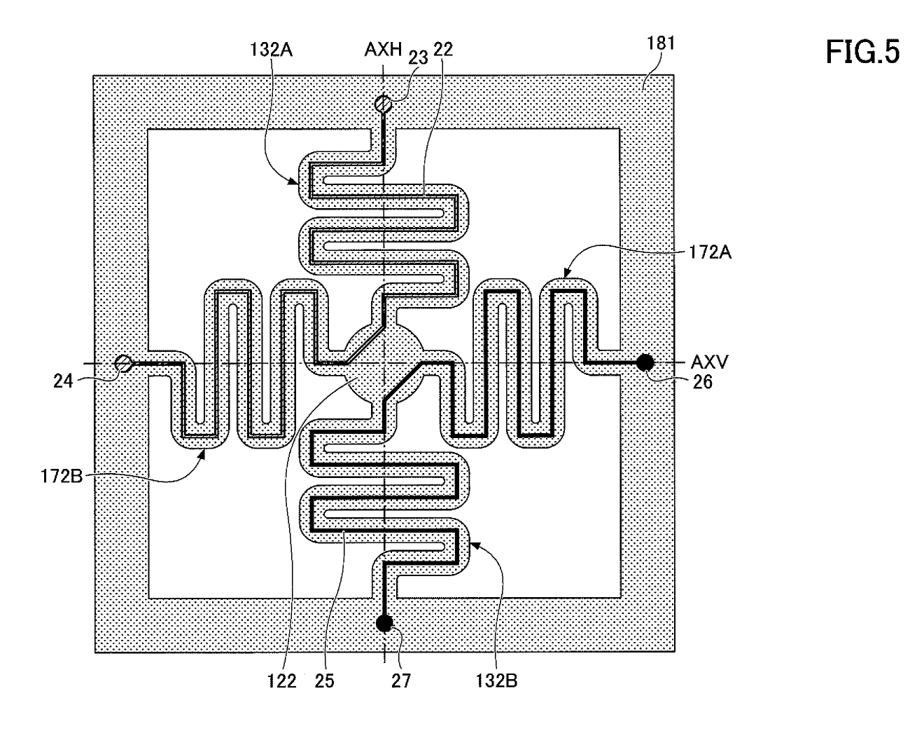

FIG. 5 is a plan view illustrating yet another example of a light scanning unit in a light scanning device according to the second embodiment. Except for a route of a wiring pattern for failure detection, a configuration of the light scanning unit in FIG. 5 is the same as that in FIG. 3 or FIG. 4. A wiring pattern for failure detection of the light scanning unit illustrated in FIG. 5 includes a first wiring pattern 22 drawn on a horizontal actuating beam 132A and a vertical actuating beam 172B, and a second wiring pattern 25 drawn on a horizontal actuating beam 132B and a vertical actuating beam 172A. The second wiring pattern 25 does not cross the first wiring pattern 22. For example, the first wiring pattern 22 is drawn from a terminal 23 on a fixing frame 181 to a terminal 24 via the horizontal actuating beam 132A, a mirror support 122, and the vertical actuating beams 172B. The second wiring pattern 25 is drawn from a terminal 26 on the fixing frame 181 to a terminal 27 via the vertical actuating beam 172A, the mirror support 122, and the horizontal actuating beam 132B, without crossing the first wiring pattern 22.

In the light scanning unit illustrated in FIG. 5, by checking a conduction state between the terminals 23 and 24, occurrence of breakage in an actuating beam on which the wiring pattern for failure detection (the first wiring pattern 22) is drawn can be detected. That is, in a case in which the first wiring pattern 22 (a path between the terminals 23 and 24) is in a conductive state, it is determined that no breakage occurs in the horizontal actuating beam 132A and the vertical actuating beams 172B on which the first wiring pattern 22 is drawn. Conversely, in a case in which the first wiring pattern 22 is not in a conductive state, it is determined that breakage occurs at a certain point in the horizontal actuating beam 132A or the vertical actuating beams 172B on which the first wiring pattern 22 is drawn. Further, by checking a conduction state between the terminals 26 and 27, occurrence of breakage in an actuating beam on which the wiring pattern for failure detection (the second wiring pattern 25) is drawn can be detected. That is, in a case in which the second wiring pattern 25 (a path between the terminals 26 and 27) is in a conductive state, it is determined that no breakage occurs in the vertical actuating beams 172A and the horizontal actuating beam 132B on which the second wiring pattern 25 is drawn. Conversely, in a case in which the second wiring pattern 25 is not in a conductive state, it is determined that breakage occurs at a certain point in the vertical actuating beams 172A or the horizontal actuating beam 132B on which the second wiring pattern 25 is drawn. As described above, in a MEMS structure functioning as an actuator, in a case in which breakage occurs in a beam located inwards from an outermost beam, the breakage can be detected regardless of whether a displacement sensor is present or not.

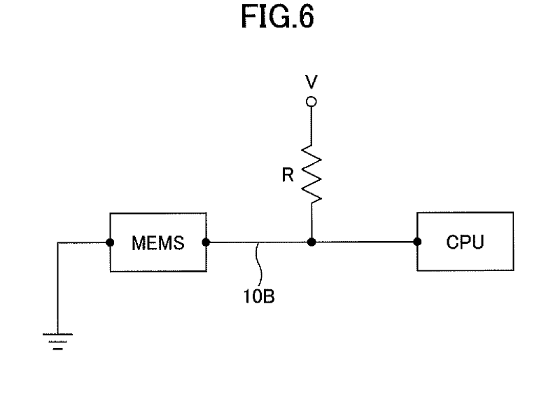

FIG. 6 is a schematic diagram of a failure detecting circuit for the light scanning unit according to the present embodiment. A wiring pattern for failure detection 10B is drawn on a MEMS structure such as the vertical actuating beams 172A and 172B and the horizontal actuating beams 132A and 132B. One of terminals of the wiring pattern for failure detection 10B is grounded, and the other terminal of the wiring pattern for failure detection 10B is connected to an input terminal of a signal processing unit such as a CPU, and the CPU can observe an output of the other terminal in real time. To an intermediate section of the wiring pattern for failure detection 10B, voltage V such as power supply voltage is applied via a resistance element R. In a case in which the failure detecting circuit is configured as illustrated in FIG. 6, if the MEMS structure such as the vertical actuating beams 172A and 172B and the horizontal actuating beams 132A and 132B is not in failure, the input terminal of the CPU is grounded. Conversely, if disconnection occurs at any point of the MEMS structure such as the vertical actuating beams 172A and 172B and the horizontal actuating beams 132A and 132B, the voltage at the input terminal of the CPU is raised towards the voltage V. In a case in which a value between the ground voltage and the voltage V is defined as a threshold, when voltage above the threshold is input to the CPU, it is determined that disconnection occurs at any point of the MEMS structure. Note that a circuit used for checking a conduction state of the wiring pattern for failure detection is not limited to the circuit illustrated in FIG. 6. Another type of circuit may be used for checking a conduction state.

The failure detecting circuit illustrated in FIG. 6 is applicable to the first embodiment. Similarly, the failure detecting circuit illustrated in FIG. 2 is applicable to the second embodiment. Further, in the following embodiments to be described below, both the failure detecting circuit illustrated in FIG. 2 and the failure detecting circuit illustrated in FIG. 6 can be employed.

### Third Embodiment

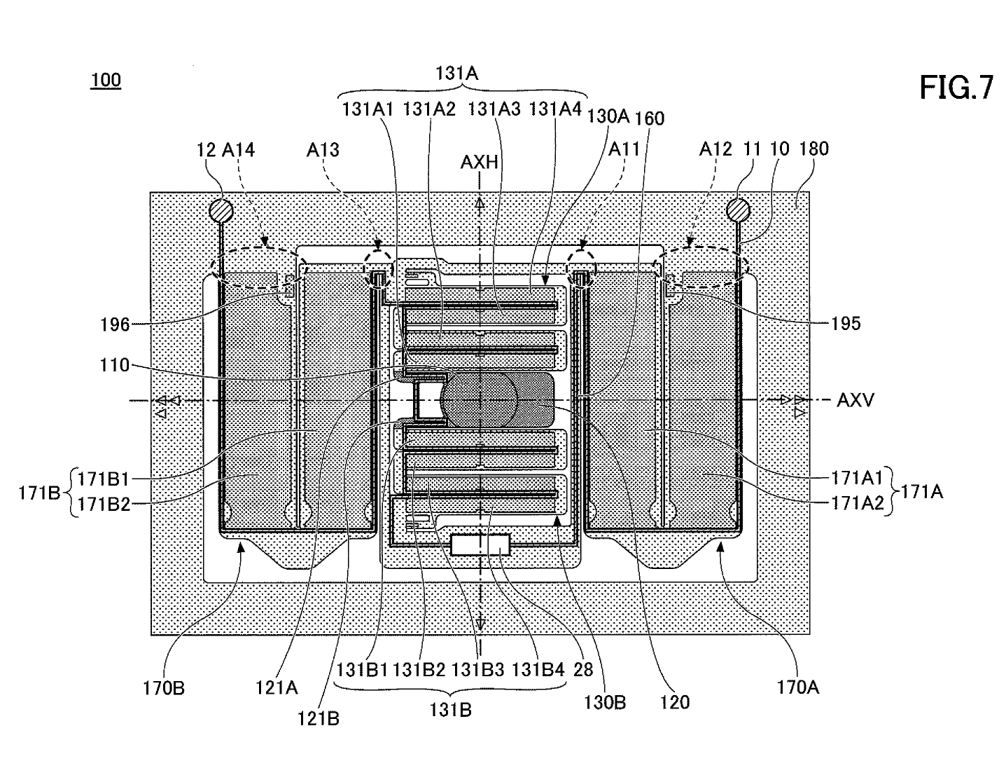

FIG. 7 is a plan view illustrating an example of an upper surface of a light scanning unit in a light scanning device according to a third embodiment. The light scanning unit illustrated in FIG. 7 is similar to that in FIG. 1, except that a resistive-type resistance thermometer 28 is provided on a path of a wiring pattern for failure detection 10, in the light scanning unit illustrated in FIG. 7. In FIG. 7, the resistance thermometer 28 is provided on the movable frame 160, on the path of the wiring pattern for failure detection 10. Normally, the resistance thermometer 28 is used for measuring temperature of the light scanning unit, by measuring resistance of the wiring pattern for failure detection 10 including the resistance thermometer 28. In a case in which electrical conduction cannot be detected from the wiring pattern for failure detection (because of disconnection), it is determined that breakage occurs in an actuating beam. As the resistance thermometer 28, a thermistor can be used. In addition, other function-specific devices may be provided on the path of the wiring pattern for failure detection 10. For example, by providing a strain gauge, a strain can be observed. Because of the wiring pattern, functions such as temperature measurement or strain measurement can be added without additional wiring.

### Fourth Embodiment

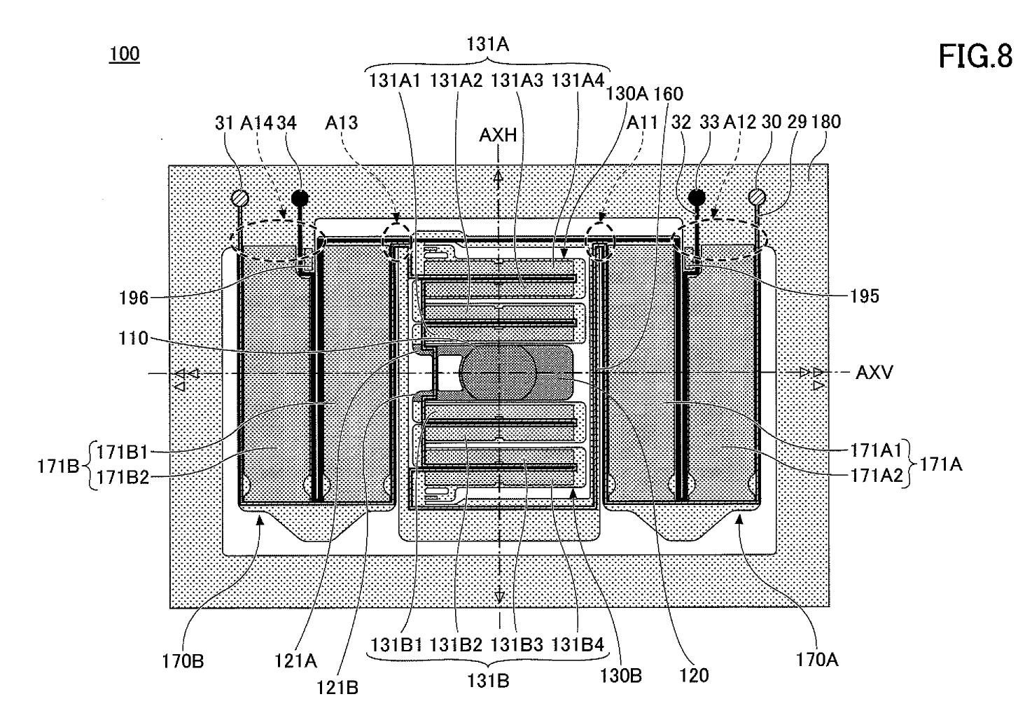

FIG. 8 is a plan view illustrating an example of an upper surface of a light scanning unit in a light scanning device according to a fourth embodiment. The light scanning unit illustrated in FIG. 8 is similar to that in FIG. 1, except that a first wiring pattern 29 and a second wiring pattern 32 are provided to the light scanning unit of FIG. 8, as a wiring pattern for failure detection.

In the light scanning device according to the present embodiment, the first wiring pattern 29 is drawn on vertical actuating beams 170A and 170B and horizontal actuating beams 130A and 130B. The first wiring pattern 29 also includes terminals 30 and 31, and the terminals 30 and 31 are formed on the fixing frame 180. For example, the first wiring pattern 29 is drawn from the terminal 30 on the fixing frame 180 to the vertical actuating beam 170A via a connecting member A12. Further, the first wiring pattern 29 is drawn from the vertical actuating beam 170A, via a connecting member A11, to upper surfaces of a movable frame 160, the horizontal actuating beam 130B, a connecting beam 121B, and a connecting beam 121A. Further, the first wiring pattern 29 is drawn on the horizontal actuating beam 130A from the connecting beams 121B and 121A, drawn on the vertical actuating beam 170B via a connecting member A13, and is connected to the terminal 31 on the fixing frame 180 via a connecting member A14.

Further, in the light scanning device according to the present embodiment, the second wiring pattern 32 is drawn on the vertical actuating beams 170A and 170B. The second wiring pattern 32 is not drawn on the horizontal actuating beams 130A and 130B. The second wiring pattern 32 includes terminals 33 and 34, and the terminals 33 and 34 are formed on the fixing frame 180. For example, the second wiring pattern 32 is drawn from the terminal 33 on the fixing frame 180 to the upper surface of the vertical actuating beam 170A via the connecting member A12, and is drawn on the movable frame 160 via the connecting member A11. Further, the second wiring pattern 32 is drawn on the vertical actuating beam 170B, from the movable frame 160 via the connecting member A13, and is connected to the terminal 34 on the fixing frame 180 via a connecting member A14.

In the light scanning unit illustrated in FIG. 8, by checking a conduction state between the terminals 30 and 31, and a conduction state between the terminals 33 and 34, occurrence of breakage in an actuating beam on which the wiring pattern for failure detection (the first and second wiring patterns 29 and 32) is drawn can be detected. That is, in a case in which a path between the terminals 30 and 31 is in a conductive state, it is determined that no breakage occurs in the vertical actuating beams 170A and 170B and the horizontal actuating beams 130A and 130B on which the first wiring pattern 29 is drawn. In a case in which a path between the terminals 30 and 31 is not in a conductive state, it is determined that breakage occurs at a certain point in the vertical actuating beams 170A and 170B or the horizontal actuating beams 130A and 130B on which the first wiring pattern 29 is drawn. In a case in which a path between the terminals 33 and 34 is in a conductive state, it is determined that no breakage occurs in the vertical actuating beams 170A and 170B on which the second wiring pattern 32 is drawn. In a case in which a path between the terminals 33 and 34 is not in a conductive state, it is determined that breakage occurs at a certain point in the vertical actuating beams 170A and 170B on which the second wiring pattern 32 is drawn.

In the light scanning unit illustrated in FIG. 8, in a case in which no electrical conduction between the terminals 30 and 31 or between the terminals 33 and 34 can be detected, that is, in a case in which both the first and second wiring patterns 29 and 32 are disconnected, it is assumed that breakage occurs in the vertical actuating beams 170A and 170B on which both the first wiring pattern 29 and the second wiring pattern 32 are drawn. Also, in a case in which electrical conduction between the terminals 33 and 34 can be detected but electrical conduction between the terminals 30 and 31 cannot be detected, that is, in a case in which the second wiring pattern 32 is not disconnected but the first wiring pattern 29 is disconnected, it is assumed that breakage occurs in the horizontal actuating beams 130A and 130B on which only the first wiring pattern 29 is drawn. As described above, in a MEMS structure functioning as an actuator, in a case in which breakage occurs in a beam located inwards from an outermost beam, the breakage can be detected regardless of whether a displacement sensor is present or not.

### Fifth Embodiment

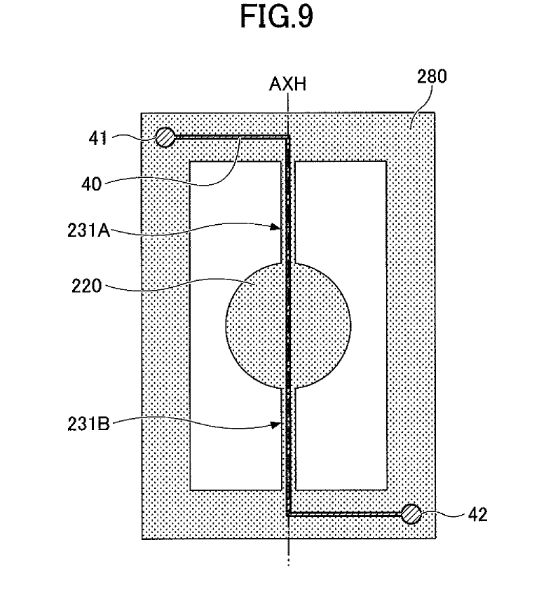

FIG. 9 is a plan view illustrating an example of an upper surface of a light scanning unit in a light scanning device according to a fifth embodiment. The light scanning unit scans laser light emitted from a light source, by oscillating a mirror. The light scanning unit is, for example, a MEMS mirror that drives the mirror by a piezoelectric element. By reflecting incident light (laser light) using the mirror, the light scanning unit performs two-dimensional scanning of light.

As illustrated in FIG. 9, the light scanning unit includes the mirror, a mirror support 220, horizontal actuating beams 231A and 231B, and a fixing frame 280. The mirror is supported on the mirror support 220. At both sides of the mirror support 220 supporting the mirror, the horizontal actuating beams 231A and 231B are provided respectively. The horizontal actuating beams 231A and 231B extend in a direction of a horizontal oscillating axis AXH, and each of the horizontal actuating beams 231A and 231B is connected to the mirror support 220 at one end, and is connected to the fixing frame 280 at the other end. The horizontal actuating beams 231A and 231B act as torsion beams for causing the mirror support 220 to oscillate around the horizontal oscillating axis AXH. Horizontal actuation sources are formed on the fixing frame 280, at a location close to the horizontal actuating beam 231A and at a location close to the horizontal actuating beam 231B. Each of the horizontal actuation sources is formed of a piezoelectric thin film, an upper electrode formed on the piezoelectric thin film, and a lower electrode formed under the piezoelectric thin film. By applying a predetermined voltage to the horizontal actuation sources, the horizontal actuating beams 231A and 231B are twisted, and the mirror support 220 oscillates around the horizontal oscillating axis AXH. Alternatively, the mirror support 220 may be actuated electromagnetically by providing coils on the mirror support 220.

In the light scanning device according to the present embodiment, a wiring pattern for failure detection 40 is formed on the horizontal actuating beams 231A and 231B. Terminals 41 and 42 are formed at one end of the wiring pattern for failure detection 40 and the other end of the wiring pattern for failure detection 40, and the terminals 41 and 42 are formed on the fixing frame 280. From the terminal 41 on the fixing frame 280, the wiring pattern for failure detection 40 is drawn on the horizontal actuating beam 231A, the mirror support 220, and the horizontal actuating beam 231B, and the wiring pattern for failure detection 40 is connected to the terminal 42 on the fixing frame 280.

In the light scanning device according to the present embodiment, by checking a conduction state between the terminals 41 and 42, occurrence of breakage in an actuating beam on which the wiring pattern for failure detection 40 is drawn can be detected. That is, in a case in which a path between the terminals 41 and 42 is in a conductive state, it is determined that no breakage occurs in the horizontal actuating beams 231A and 231B on which the wiring pattern for failure detection 40 is drawn. In a case in which a path between the terminals 41 and 42 is not in a conductive state, it is determined that breakage occurs at a certain point in the horizontal actuating beams 231A and 231B on which the wiring pattern for failure detection 40 is drawn. As described above, in a MEMS structure functioning as an actuator, breakage of a beam can be detected regardless of whether a displacement sensor is present or not.

### Sixth Embodiment

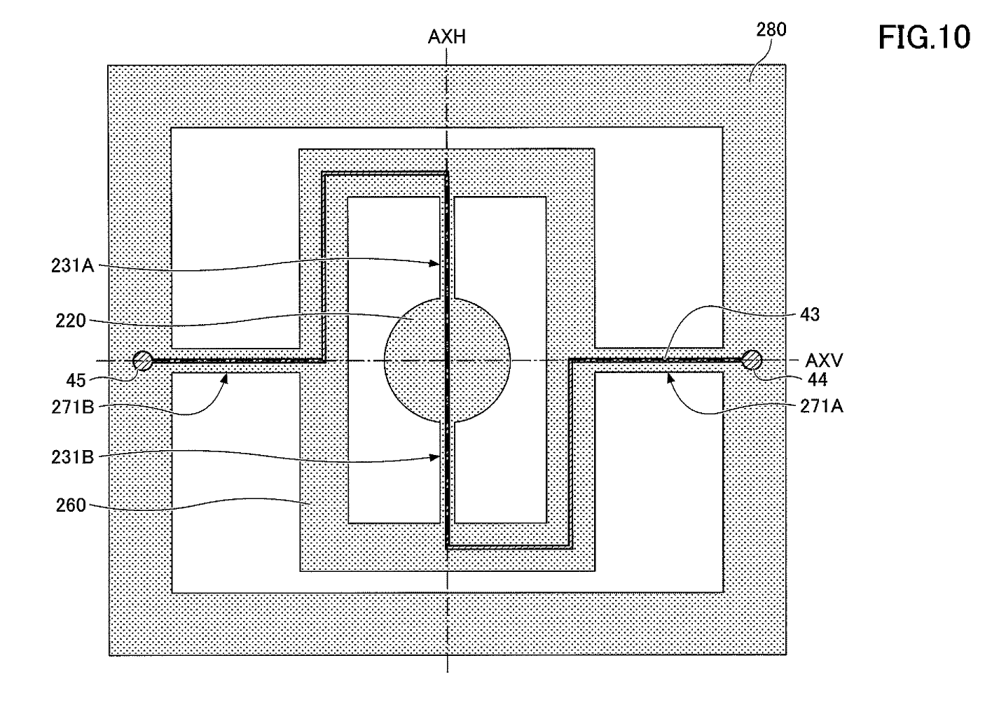

FIG. 10 is a plan view illustrating an example of an upper surface of a light scanning unit in a light scanning device according to a sixth embodiment. The light scanning unit scans laser light emitted from a light source, by oscillating a mirror. The light scanning unit is, for example, a MEMS mirror that drives the mirror by a piezoelectric element. By reflecting incident light (laser light) using the mirror, the light scanning unit performs two-dimensional scanning of light.

As illustrated in FIG. 10, the light scanning unit includes the mirror, a mirror support 220, horizontal actuating beams 231A and 231B, a movable frame 260, vertical actuating beams 271A and 271B, and a fixing frame 280. The mirror is supported on the mirror support 220. At both sides of the mirror support 220 supporting the mirror, a pair of the horizontal actuating beams 231A and 231B are provided respectively. The horizontal actuating beams 231A and 231B extend in a direction of a horizontal oscillating axis AXH, and each of the horizontal actuating beams 231A and 231B is connected to the mirror support 220 at one end, and is connected to the movable frame 260 at the other end. The horizontal actuating beams 231A and 231B act as torsion beams for causing the mirror support 220 to oscillate around the horizontal oscillating axis AXH. Horizontal actuation sources are formed on the movable frame 260. Each of the horizontal actuation sources is formed of a piezoelectric thin film, an upper electrode formed on the piezoelectric thin film, and a lower electrode formed under the piezoelectric thin film. By applying predetermined voltage to the horizontal actuation sources, the horizontal actuating beams 231A and 231B are twisted, and the mirror support 220 oscillates around the horizontal oscillating axis AXH. At both sides of the movable frame 260, the vertical actuating beams 271A and 271B are provided respectively, and the vertical actuating beams 271A and 271B are connected to the movable frame 260. The vertical actuating beams 271A and 271B extend in a direction of a vertical oscillating axis AXV, and each of the vertical actuating beams 271A and 271B is connected to the movable frame 260 at one end, and is connected to the fixing frame 280 at the other end. The vertical actuating beams 271A and 271B act as torsion beams for causing the movable frame 260 to oscillate around the vertical oscillating axis AXV. Vertical actuation sources are formed on the fixing frame 280, at a location close to the vertical actuating beam 271A and at a location close to the vertical actuating beam 271B. Each of the vertical actuation sources is formed of a piezoelectric thin film, an upper electrode formed on the piezoelectric thin film, and a lower electrode formed under the piezoelectric thin film. By applying predetermined voltage to the vertical actuation sources, the vertical actuating beams 271A and 271B are twisted, and the movable frame 260 oscillates around the vertical oscillating axis AXV.

In the light scanning device according to the present embodiment, a wiring pattern for failure detection 43 is formed on the horizontal actuating beams 231A and 231B and the vertical actuating beams 271A and 271B. The wiring pattern for failure detection 43 has a terminal 44 at one end, and has a terminal 45 at the other end, and the terminals 44 and 45 are formed on the fixing frame 280. From the terminal 44 on the fixing frame 280, the wiring pattern for failure detection 43 is drawn on the vertical actuating beam 271A, the movable frame 260, the horizontal actuating beam 231B, the mirror support 220, the horizontal actuating beam 231A, the movable frame 260, and the vertical actuating beam 271B, and the wiring pattern for failure detection 43 is connected to the terminal 45 on the fixing frame 280.

In the light scanning unit illustrated in FIG. 10, by checking a conduction state between the terminals 44 and 45, occurrence of breakage in an actuating beam on which the wiring pattern for failure detection 43 is drawn can be detected. That is, in a case in which a path between the terminals 44 and 45 is in a conductive state, it is determined that no breakage occurs in actuating beams (the horizontal actuating beams 231A and 231B, and the vertical actuating beams 271A and 271B) on which the wiring pattern for failure detection 43 is drawn. In a case in which a path between the terminals 44 and 45 is not in a conductive state, it is determined that breakage occurs at a certain point in the actuating beams on which the wiring pattern for failure detection 43 is drawn. As described above, in a MEMS structure functioning as an actuator, breakage of a beam can be detected regardless of whether a displacement sensor is present or not.

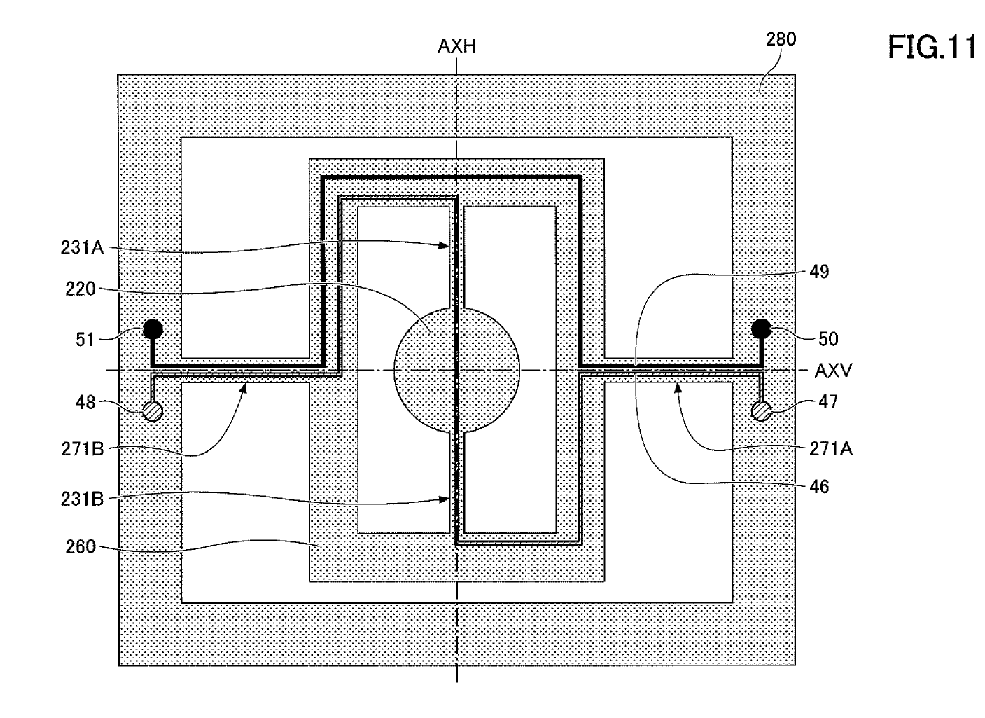

FIG. 11 is a plan view illustrating another example of an upper surface of a light scanning unit in a light scanning device according to the sixth embodiment. The light scanning unit in FIG. 11 is similar to that in FIG. 10, except that a first wiring pattern 46 and a second wiring pattern 49 are provided, as a wiring pattern for failure detection, on the light scanning unit in FIG. 11.

In the light scanning device according to the present embodiment, the first wiring pattern 46 is drawn, from a terminal 47 on the fixing frame 280, on the vertical actuating beam 271A, the movable frame 260, the horizontal actuating beam 231B, the mirror support 220, the horizontal actuating beam 231A, the movable frame 260, and the vertical actuating beam 271B, and the first wiring pattern 46 is connected to a terminal 48 on the fixing frame 280. The second wiring pattern 49 is drawn, from a terminal 50 on the fixing frame 280, on the vertical actuating beam 271A, the movable frame 260, and the vertical actuating beam 271B, and the second wiring pattern 49 is connected to a terminal 51 on the fixing frame 280. The second wiring pattern 49 is not drawn on the horizontal actuating beams 231A and 231B.

In the light scanning unit illustrated in FIG. 11, by checking a conduction state between the terminals 47 and 48, and a conduction state between the terminals 50 and 51, occurrence of breakage in an actuating beam on which the wiring pattern for failure detection (the first or second wiring pattern 46 or 49) is drawn can be detected. That is, in a case in which a path between the terminals 47 and 48 is in a conductive state, it is determined that no breakage occurs in the vertical actuating beams 271A and 271B and the horizontal actuating beams 231A and 231B on which the first wiring pattern 46 is drawn. In a case in which a path between the terminals 47 and 48 is not in a conductive state, it is determined that breakage occurs at a certain point in the vertical actuating beams 271A and 271B and the horizontal actuating beams 231A and 231B on which the first wiring pattern 46 is drawn. In a case in which a path between the terminals 50 and 51 is in a conductive state, it is determined that no breakage occurs in the vertical actuating beams 271A and 271B on which the second wiring pattern 49 is drawn. In a case in which a path between the terminals 50 and 51 is not in a conductive state, it is determined that breakage occurs at a certain point in the vertical actuating beams 271A and 271B on which the second wiring pattern 49 is drawn.

In the light scanning unit illustrated in FIG. 11, in a case in which no electrical conduction between the terminals 47 and 48 or between the terminals 50 and 51 can be detected, that is, in a case in which both the first and second wiring patterns 46 and 49 are disconnected, it is assumed that breakage occurs in the vertical actuating beams 271A and 271B on which both the first wiring pattern 46 and the second wiring pattern 49 are drawn. Also, in a case in which electrical conduction between the terminals 50 and 51 can be detected but electrical conduction between the terminals 47 and 48 cannot be detected, that is, in a case in which the second wiring pattern 49 is not disconnected but the first wiring pattern 46 is disconnected, it is assumed that breakage occurs in the horizontal actuating beams 231A and 231B on which only the first wiring pattern 46 is drawn. As described above, in a MEMS structure functioning as an actuator, breakage can be detected regardless of whether a displacement sensor is present or not.

Although preferable embodiments of the present invention have been described above, the present invention is not limited to the above-described embodiments. Various changes or enhancements can be made hereto within the scope of the present invention. For example, the above described embodiments describe a case in which an actuator is applied to a light scanning device having a mirror. However, what is driven by an actuator is not limited to a mirror, and the present invention is applicable to an actuator driving an article other than a mirror. Further, a light scanning device according to the above described embodiments is preferably applicable to optical coherence tomography for a funduscopic apparatus. In the optical coherence tomography for a funduscopic apparatus, different from a projection apparatus, a resonant actuation for high speed drive of a mirror is not required. Rather, as it is required that an oscillating angle of a mirror for scanning light can be freely configured, a light scanning device configured to drive a mirror by using a non-resonant actuation in both horizontal and vertical directions, as described in the above embodiments, is preferable. In a case in which the present invention is applied to an optical coherence tomography for a funduscopic apparatus, the optical coherence tomography can be configured to detect breakage of an actuating beam immediately and to stop emitting laser light in response to the detection of breakage of an actuating beam. Thus, in the optical coherence tomography to which the present invention is applied, even when breakage of an actuating beam has occurred, the optical coherence tomography can avoid damaging a fundus by emitting laser light to a specific point. The present invention can also be applied to a projecting apparatus, or a sensor such as an acceleration sensor. In a case in which the present invention is applied to a sensor, if breakage of an actuating beam occurs, a sensitivity of the sensor degrades and an erroneous value is output. By detecting breakage of an actuating beam quickly, a state in which breakage of an actuating beam has occurred can be detected quickly.

What is claimed is:

1. An actuator comprising:
an actuation object;
a first actuating beam supporting the actuation object;
a fixing frame supporting the first actuating beam;
a first actuation source configured to cause the actuation object to oscillate around a first axis, by actuating the first actuating beam; and
a first wiring pattern for failure detection drawn on the first actuating beam, a terminal of the first wiring pattern for failure detection being disposed on the fixing frame.

2. The actuator according to claim 1,
wherein the first actuating beam is formed of a plurality of first beams arranged side by side, each of the first beams extending in a direction orthogonal to the first axis, and
each of the first beams is linked together to form a meander shape as a whole.

3. The actuator according to claim 1,
wherein the first actuating beam is a torsion beam extending along the first axis.

4. The actuator according to claim 1, further comprising
a movable frame surrounding a periphery of the actuation object;
a second actuating beam supporting the actuation object, the second actuating beam being connected to an inner periphery of the movable frame; and
a second actuation source configured to cause the actuation object to oscillate around a second axis, by actuating the second actuating beam;
wherein the actuation object is supported by the first actuating beam via the movable frame and the second actuating beam.

5. The actuator according to claim 4, wherein
the first wiring pattern for failure detection is drawn on the first actuating beam and the second actuating beam.

6. The actuator according to claim 4, further comprising a second wiring pattern for failure detection drawn on the first actuating beam and the second actuating beam, a terminal of the second wiring pattern for failure detection being disposed on the fixing frame; wherein
the first wiring pattern for failure detection is configured to avoid being drawn on the second actuating beam.

7. The actuator according to claim 4,
wherein the second actuating beam is formed of a plurality of second beams arranged side by side, each of the second beams extending in a direction orthogonal to the second axis, and
each of the second beams is linked together to form a meander shape as a whole.

8. The actuator according to claim 4,
wherein the second actuating beam is a torsion beam extending along the second axis.

9. The actuator according to claim 2, further comprising
a second actuating beam supporting the actuation object, the second actuating beam being formed of a plurality of second beams arranged side by side, each of the second beams extending in a direction orthogonal to a second axis; and
a second actuation source configured to cause the actuation object to oscillate around the second axis, by actuating the second actuating beam;
wherein each of the second beams is linked together to form a meander shape as a whole.

10. The actuator according to claim 9, wherein
the first wiring pattern for failure detection is drawn on the first actuating beam and the second actuating beam.

11. The actuator according to claim 10, wherein
the first wiring pattern for failure detection includes a first wire and a second wire each of which is drawn on the first actuating beam and the second actuating beam, and
the first wire and the second wire cross on the actuation object.

12. The actuator according to claim 10, wherein
the first wiring pattern for failure detection includes a first wire and a second wire each of which is drawn on the first actuating beam and the second actuating beam, and
the first wire and the second wire are separated from each other.

13. The actuator according to claim 1, wherein a function-specific device is provided on the first wiring pattern for failure detection.

14. A light scanning device comprising:
a mirror;
a mirror supporting member supporting the mirror;
an actuating beam supporting the mirror supporting member;
a fixing frame supporting the actuating beam;
an actuation source configured to cause the mirror supporting member to oscillate around a predetermined axis, by actuating the actuating beam; and
a wiring pattern for failure detection drawn on the actuating beam, a terminal of the wiring pattern for failure detection being disposed on the fixing frame.
